(19) United States
(12) Patent Application Publication
(10) Pub. No.: US 2012/0002189 A1
(43) Pub. Date: Jan. 5, 2012

(54) APPARATUS FOR DETERMINING A FLOW PROPERTY OF A FLUID

(75) Inventors: Jaione Bengoechea Apezteguia, Arraioz (ES); Mark Carpaij, Hertogenbosch (NL); Alexander Marc Van Der Lee, Venlo (NL); Ulrich Weichmann, Aachen (JP)

(73) Assignee: KONINKLIJKE PHILIPS ELECTRONICS N.V., Eindhoven (NL)

(21) Appl. No.: 13/256,837

(22) PCT Filed: Mar. 15, 2010
(86) PCT No.: PCT/IB10/51108

§ 371 Date: Sep. 15, 2011

(30) Foreign Application Priority Data
Mar. 18, 2009 (EP) 09155526.8

(51) Int. Cl. G01P 3/36

(52) U.S. Cl. 356/28.5

(57) ABSTRACT

The invention relates to an apparatus (1) for determining a flow property of a fluid (2). The apparatus comprises a distance and velocity determination unit (3) for determining distances of elements of the fluid to the distance and velocity determination unit (3) and for determining velocities of the elements at the same time based on a self-mixing interference signal. The apparatus (1) comprises further a flow determination unit (4) for determining the flow property of the fluid (2) based on at least one of the determined distances and velocities. This allows determining the flow property, even if the fluid (2) is optically thick.

### FIELD OF THE INVENTION

The present invention relates to an apparatus, a method and a computer program for determining a flow property of a fluid.

### BACKGROUND OF THE INVENTION

The article “Detection of small particles in fluid flow using a self-mixing laser”, S. Sudo et al., Optics Express, Vol. 115, Issue 13, pp. 8135-8145 discloses a real-time method for detecting small particles in a fluid flow by self-mixing laser Doppler measurement with a laser-diode-pumped, thin-slice solid state laser with extremely high optical sensitivity. Asymmetric power spectra of the laser output modulated by re-injected scattered light from the small particles moving in a dilute sample-flow, through a small-diameter glass pipe, are observed and are shown to reflect the velocity distribution of the fluid flow, which obeys Poiseuille's law. A dependency of the velocity distribution of the fluid flow on the asymmetric power spectra is determined and used for determining the velocity distribution of the fluid flow based on measured asymmetric power spectra.

This method has the drawback that the fluid flow can only be determined, if the fluid flow has a small optical thickness. For larger optical thicknesses the fluid flow cannot be determined.

### SUMMARY OF THE INVENTION

It is an object of the present invention to provide an apparatus, a method and a computer program for determining a flow property of a fluid, which allow determining flow properties for larger optical thicknesses of the fluid.

In an aspect of the present invention an apparatus for determining a flow property of a fluid is provided, wherein the apparatus comprises:
a distance and velocity determination unit for determining distances of elements of the fluid to the distance and velocity determination unit and for determining velocities of the elements at the same time, the distance and velocity determination unit comprising a laser with a laser cavity, wherein the distance and velocity determination unit is adapted to generate a self-mixing interference signal by directing laser radiation generated within the laser cavity to the fluid for being reflected by the fluid and by mixing the reflected radiation with the radiation within the laser cavity and to determine the distances and the velocities based on the generated self-mixing interference signal,
a flow determination unit for determining the flow property of the fluid based on at least one of the determined distances and velocities.

Since distances of the elements of the fluid to the distance and velocity determination unit and velocities of the elements are determined at the same time, it is known at which distances to the distance and velocity determination unit the elements are located and which velocities these elements have at these distances. This allows determining the flow property of the fluid based on at least one of the determined distances and velocities. For example, if the optical thickness of the fluid is low such that the determined distances of the elements are not necessarily needed for determining a desired flow property, for example, because the laser radiation can penetrate deeply into the fluid such that velocities are determined being sufficient for determining the desired flow property, the flow determination unit can determine the flow property based on the determined velocities only. However, if the optical thickness is such that the determined velocities are not sufficient for determining the flow property, for example, because the laser radiation cannot penetrate deep enough into the fluid, the flow determination unit can use the determined velocities and the determined distances for determining the flow property. Thus, even if the optical thickness is large, a flow property can be determined by using the velocities and distances, which have been determined at the same time.

The distance and velocity determination unit is adapted to generate a self-mixing interference signal by directing laser radiation generated within a laser cavity to the fluid for being reflected by the fluid and by mixing the reflected radiation with the radiation within the laser cavity. This mixing within the laser cavity results in undulations of the laser power, which can be detected as the self-mixing interference signal. This self-mixing interference signal depends on the velocities and distances of elements of the fluid, wherein the distance and velocity determination unit is adapted to determine the distances and velocities of these elements of the fluid from the generated self-mixing interference signal.

The determination of the distances and velocities of the elements of the fluid at the same time means that the same reflected radiation, which has been reflected by an element, is used for determining the distance and the velocity of this element, i.e. the determined distance and velocity of this element describe the distance and velocity of this element at the same time.

The elements of the fluid are, for example, elements of the fluid itself and/or elements that have been added to the fluid.

That the flow determination unit is adapted to determine the flow property of the fluid based on at least one of the determined distances and velocities means that the distances, the velocities or both, the distances and the velocities, are used for determining the flow property of the fluid.

It is preferred that the flow determination unit is adapted to determine at least one of the maximum flow velocity and the volume flow as the property of the fluid. The volume flow is preferentially defined as the volume of the fluid, which flows through a cross section of the fluid, in a predefined time interval. Thus, the volume flow can also be regarded as a volume flow rate.

It is further preferred that the distance and velocity determination unit is adapted to:
determine Doppler frequencies from the self-mixing interference signal,
determine the maximum Doppler frequency of the determined Doppler frequencies,
determine the maximum flow velocity of the elements of the fluid from the determined maximum Doppler frequency,

wherein the flow determination unit is adapted to determine the maximum flow velocity as the flow property. This allows determining the maximum flow velocity easily and with high accuracy.

It is further preferred that the flow determination unit is adapted to:
provide a volume flow function defining the relation between the maximum flow velocity and a volume flow,
determine the volume flow as the flow property by using the volume flow function and the maximum flow velocity.

It is further preferred that the apparatus further comprises a flow width determination unit for determining the width of the flow from the determined distances of the elements.

If the laser radiation traverses the flow, beyond the flow no reflecting or scattering elements are present, or, if the fluid is located in a tube, no reflecting or scattering elements are present beyond the edge of the tube, and hence no distance information will come back from beyond the flow or beyond the tube, respectively. Furthermore, in front of the flow, or, if the fluid is located in the tube, in front of the tube, with respect to the propagation direction of the emitted laser radiation, no scattering or reflecting elements of the fluid are present and hence no distance information will come back from this location. Thus, by determining the closest distance and the largest distance to the distance and velocity determination unit the width of the flow can be determined. This determined width can, for example, be used for determining whether the laser radiation penetrates the flow completely or not, for example, by comparing the determined width with a known width of the flow.

It is further preferred that the flow determination unit is adapted to:
provide a flow model function defining velocities of the elements of the fluid depending on the distances of the elements to the distance and velocity determination unit,
fit the flow model function to the determined distances and velocities of the elements,
determine the flow property from the fitted flow model function.

The flow model is preferentially a laminar flow model, which assumes that the maximum flow velocity is located in the middle of the flow and zero flow values are located at the edge of the flow.

The fitting of the flow model function to the determined distances and velocities of the elements of the fluid can be performed, even if only the distances and velocities of a few elements of the fluid have been determined. Thus, this fitting can be performed, even if the fluid is optically thick. This therefore further improves the ability to determine a flow property for fluids having a large optical thickness.

It is further preferred that the apparatus further comprises:
a flow width determination unit for determining the width of the flow from the determined distances of the elements,

wherein the distance and velocity determination unit and the flow determination unit are adapted such that

a) if the determined width is equal to or larger than a predefined maximal velocity width, the distance and velocity determination unit determines the maximum frequency of the self-mixing interference signal and determines the maximum flow velocity of the elements of the fluid from the determined maximum frequency, and the flow determination unit determines the maximum flow velocity as the flow property,

b) if the determined width is smaller than the predefined maximal velocity width, the flow determination unit provides a flow model function defining velocities of elements of the fluid depending on the distances of the elements to the distance and velocity determination unit, fits the flow model function to the determined distances and velocities of the elements, and determines the flow property from the fitted flow model function.

The predefined maximal velocity width defines the width of the flow, which has at least to be determined by the flow width determination unit, in order to allow determining the maximum flow velocity from the generated self-mixing interference signal. This determined width of the flow depends on the optical thickness of the fluid, i.e. the penetration depth of the radiation in the fluid. Thus, by determining a flow property of the fluid in dependence on the determined width of the flow, the determination of the flow property depends on the optical thickness of the fluid. If the optical thickness is low such that the laser radiation reaches the maximal velocity width, the distance and velocity determination unit and the flow determination unit are adapted to determine a maximum flow velocity by determining Doppler frequencies from the self-mixing interference signal, by determining the maximum Doppler frequency of the determined Doppler frequencies, and by determining the maximum flow velocity of the elements of the fluid from the determined maximum Doppler frequency. If the optical thickness is large such that the laser radiation cannot reach the maximum velocity width, the flow determination unit provides the flow model function defining velocities of the elements of the fluid depending on the distances of the elements to the distance and velocity determination unit, fits the model function to the determined distances and velocities of the elements, and determines the flow property from the fitted flow model function. This allows determining the flow property of the fluid depending on the optical thickness of the fluid.

It is further preferred that the flow determination unit is adapted to determine whether a flow of the fluid is laminar or turbulent from the self-mixing interference signal as the flow property. The determination whether the flow of the fluid is laminar or turbulent can be used to control the flow of the fluid such that the flow remains or becomes laminar. For example, if the fluid is pumped through a tube, the pump pressure can be controlled such that, if the flow is turbulent, the pump pressure is reduced such that the flow becomes laminar. This optimizes losses in the flow due to internal friction.

Preferentially, the flow determination unit is adapted to determine that the flow is turbulent, if a frequency spectrum of the self-mixing interference signal has a chaotic behavior, and wherein the flow determination unit is adapted to determine that the flow is laminar, if a frequency spectrum of the self-mixing interference signal has not a chaotic behavior.

In a further aspect of the present invention a method for determining a flow property of a fluid is provided, wherein the method comprises the steps of:
determining distances of elements of the fluid to the distance and velocity determination unit and for determining velocities of the elements at the same time, wherein a self-mixing interference signal is generated by directing laser radiation generated within a laser cavity to the fluid for being reflected by the fluid, wherein the reflected radiation is mixed with the radiation within the laser cavity and wherein the distances and the velocities are determined based on the generated self-mixing interference signal,
determining the flow property of the fluid based on at least one of the determined distances and velocities.

In a further aspect of the present invention a computer program for determining a flow property of a fluid is provided, wherein the computer program comprises program code means for causing an apparatus as defined in claim 1 to carry out the steps of the method as defined in claim 10, when the computer program is run on a computer controlling the apparatus.

It shall be understood that a preferred embodiment of the invention can also be any combination of the dependent claims with the respective independent claim.

### DETAILED DESCRIPTION OF THE DRAWINGS

These and other aspects of the invention will be apparent from and elucidated with reference to the embodiments described hereinafter. In the following drawings:

### BRIEF DESCRIPTION OF THE DRAWINGS

FIG. 1 shows schematically and exemplary an embodiment of an apparatus for determining a flow property of a fluid,

FIG. 2 shows schematically and exemplarily an embodiment of a distance and velocity determination unit of the apparatus for determining a flow property of a fluid,

FIG. 3 shows schematically and exemplarily a normalized velocity depending on normalized positions within a flow of a fluid,

FIG. 4 shows schematically and exemplarily a number of elements depending on the normalized velocity within a flow of fluid,

FIG. 5 shows schematically and exemplarily a spectrum of a self-mixing interference signal,

FIG. 6 shows schematically and exemplarily an arrangement for determining a flow property of a fluid and

FIG. 7 shows exemplarily a flow chart illustrating an embodiment of a method for determining a flow property of a fluid.

### DETAILED DESCRIPTION OF EMBODIMENTS

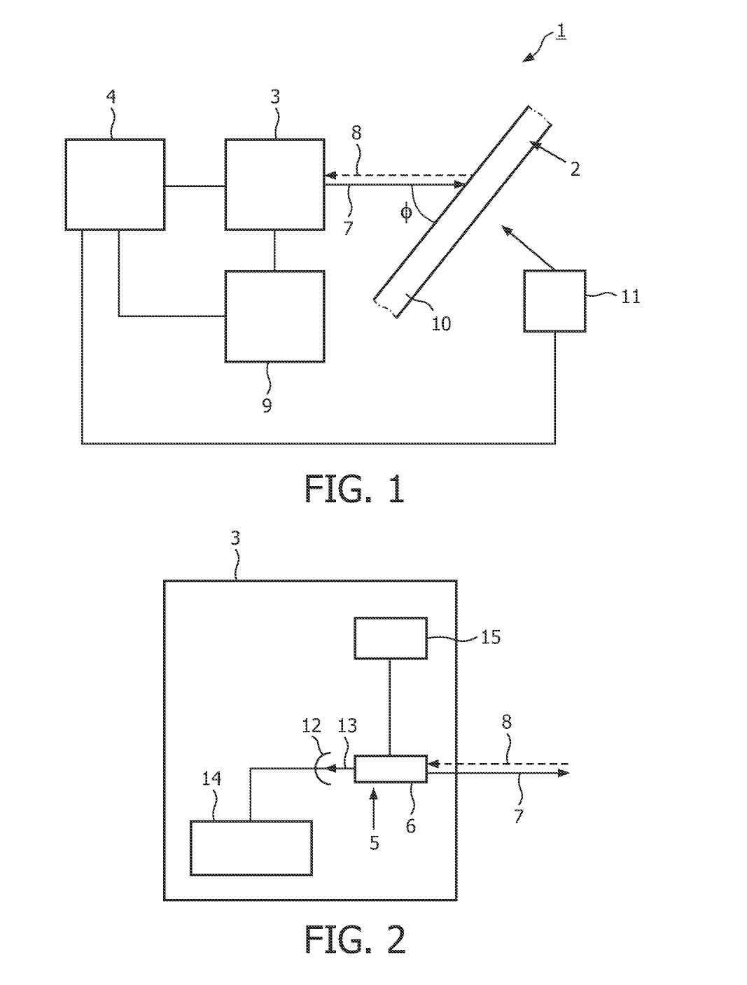

FIG. 1 shows schematically and exemplarily an apparatus 1 for determining a flow property of a fluid 2. The apparatus comprises a distance and velocity determination unit 3 for determining distances of elements of the fluid to the distance and velocity determination unit 3 and for determining velocities of the elements at the same time. The distance and velocity determination unit 3 comprises a laser 5 with a laser cavity 6 (shown in FIG. 2). The distance and velocity determination unit 3 is adapted to generate a self-mixing interference signal by directing laser radiation 7 generated within the laser cavity 6 to the fluid 2 for being reflected by the fluid 2 and by mixing the reflected radiation 8 with the radiation within the laser cavity 6. The distance and velocity determination unit 3 is further adapted to determine the distances and the velocities based on the generated self-mixing interference signal.

The apparatus 1 for determining a flow property of the fluid 2 further comprises a flow determination unit 4 for determining the flow property of the fluid 2 based on at least one of the determined distances and velocities.

In this embodiment, the fluid 2 flows within a tube 10.

A pump 11 which is only schematically shown in FIG. 1 might be present for controlling the flow of the fluid 2 within the tube 10. The pump 11 can be connected with the flow determination unit 4, in order to control the pump 11 such that a predetermined flow value is obtained.

The distance and velocity determination unit 3 is adapted to generate a self-mixing interference signal by directing the laser radiation 7 generated within the laser cavity 6 to the fluid 2 for being reflected by the fluid 2 and by mixing the reflected radiation 8 with the radiation within the laser cavity 6. This mixing within the laser cavity 6 results in undulations of the laser power, which is detected by the detector 12 shown in FIG. 2. The detector 12 detects the laser power by detecting the intensity of radiation 13 coupled out of the laser cavity 6. The self-mixing interference signal detected by the detector 12 depends on the velocities and distances of elements of the fluid 2 and the distance and velocity determination unit 3 comprises an analyzing unit 14 being adapted to determine the distances and velocities of these elements of the fluid 2 from the generated self-mixing interference signal.

The distance and velocity determination unit determines firstly the component of the velocity in the direction of the radiation 7, wherein the velocity in the flow direction is determined trigonometrically by knowing the angle between the flow direction and the direction of the radiation 7, for example, by multiplying the component in the direction of the radiation 7 by the cosine of this angle.

The flow determination unit 4 is adapted to determine at least one of the maximum flow velocity and the volume flow as the property of the fluid. The volume flow is preferentially defined as the volume of the fluid 2, which flows through a cross section of the fluid, in a predefined time interval. Thus, the volume flow can also be regarded as a volume flow rate.

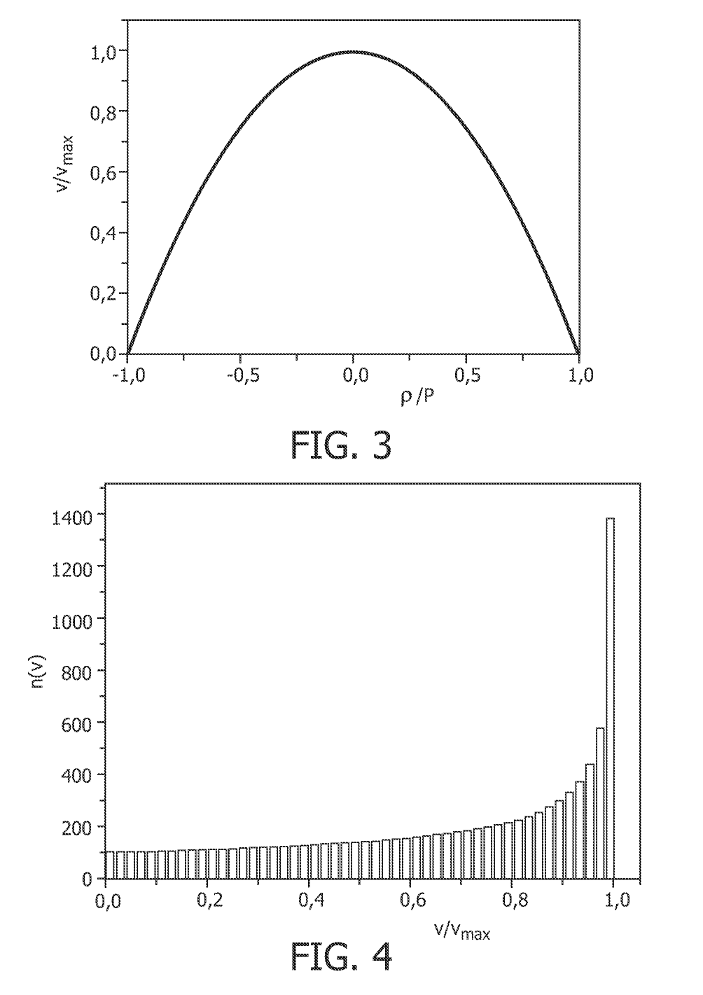

The flow of the fluid 2 is preferentially a laminar flow, which is characterized by a parabolic velocity distribution. For the laminar flow of liquids in the tube 10 the velocities at the tube boundary are zero and have a maximum value in the center of the tube 10. This is exemplarily and schematically shown in FIG. 3.

FIG. 3 shows a normalized velocity v/vₘₐₓ depending on a normalized radius ρ/P of the tube 10. A normalized radius of 0.0 indicates the center of the tube 10 and a normalized radius of −1.0 and 1.0 indicates the tube boundary. The velocity distribution shown in FIG. 3 can be expressed by following equation:

$$v ( ρ ) = {v}_{max} ( 1 - \frac{{ρ}^{2}}{{P}^{2}} ) , \qquad ( 1 )$$

wherein v(ρ) indicates the velocity of elements of the fluid 2 at the radius ρ, wherein vₘₐₓ indicates the maximum velocity at the center of the tube 10 and wherein P indicates the radius of the tube 10.

If a uniform density of scattering elements within a fluid 2 is assumed, a distribution of the number of particles n(v) at the different velocities v can be obtained as schematically and exemplarily shown in FIG. 4.

In FIG. 4 it can be seen that most elements travel at maximum speed due to the parabolic nature of the velocity profile in laminar flows. The maximum velocity in this figure is characterized by a steep increase in the number of fluid elements towards maximum velocity. The strength of the measured self-mixing interference signal at a certain velocity is proportional to the number of fluid elements at this velocity. The maximum velocity point will be marked by strong peak in the self-mixing interference signal for optically thin fluids.

The volume flow ΔV/Δt is preferentially determined by integrating the velocity profile defined in equation (1) over the tube area. This results in following equation:

$$\frac{Δ V}{Δ t} = \frac{π {P}^{2} {v}_{max}}{2} . \qquad ( 2 )$$

In an embodiment, the distance and velocity determination unit 3, in particular, the analyzing unit 14, is adapted to determine Doppler frequencies from the self-mixing interference signal. Preferentially, the distance and velocity determination unit 3 uses the following equation for determining a velocity from a Doppler frequency:

$${f}_{Doppler} = \frac{2 v \cdot cos φ}{λ} , \qquad ( 3 )$$

wherein f_{Doppler} denotes the Doppler frequency, v·cos φ denotes the velocity component along the direction of the laser beam 7 in FIG. 1 and λ denotes the wave length of the undisturbed laser 5. The feedback from the elements flowing in the fluid 2 generates a changing interference signal inside the laser cavity 6 with this Doppler frequency being the self-mixing interference signal. Hence, the laser output power detected by the detector 12 is modulated with a frequency, from which the velocity of the scattering elements within the fluid can be derived. Thus, by using equation (3) the velocities of the elements of the fluid 2 can be determined based on the determined Doppler frequencies.

In an embodiment, the distance and velocity determination unit 3, in particular, the analyzing unit 14, is adapted to determine the maximum Doppler frequency of the determined Doppler frequencies and to determine the maximum flow velocity of the elements of the fluid 2 from the determined maximum Doppler frequency by using equation (3). In this embodiment, the flow determination unit 4 is adapted to determine the maximum flow velocity as the flow property. Moreover, preferentially the flow determination unit 4 is adapted to determine the volume flow by using the determined maximum flow velocity and equation (2).

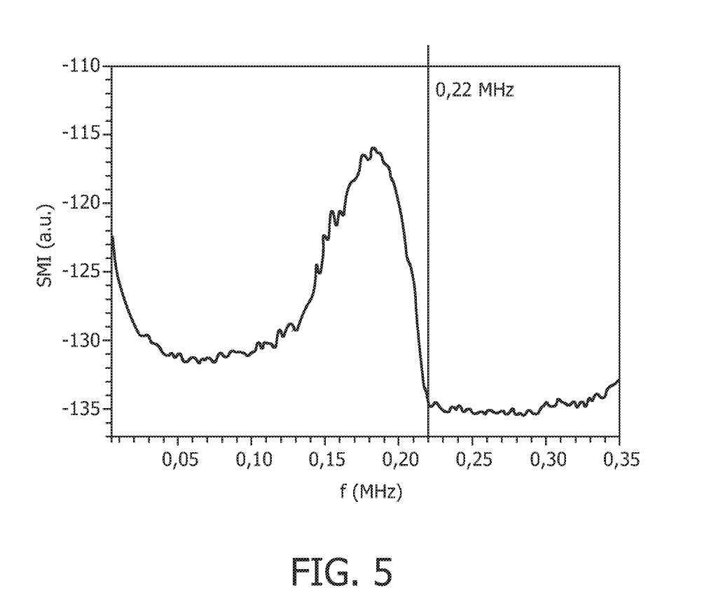

An example for a spectrum of a self-mixing interference signal in arbitrary units for a transparent fluid is shown in FIG. 5. In this example, the modulation apparatus 15 does not modulate the frequency of the laser 5, i.e. the shown spectrum is also a spectrum of Doppler frequencies. The spectrum is preferentially obtained by averaging over multiple individual power spectra of the self-mixing interference signal. In the example shown in FIG. 5 the frequency spectrum has a clear peak and after the observed frequencies decay rapidly, the maximum frequency is at about 0.22 MHz. Preferentially, an amplifier is used for measuring the self-mixing interference signal. The use of such an amplifier might introduce an artifact in the spectrum of the self-mixing interference signal being, for example, a peak at DC as can be seen in FIG. 5.

Preferentially, the fluid is regarded as transparent, if the radiation 7 of the laser 5 can reach the elements of the fluid having the maximum flow velocity, in particular, if the radiation 7 of the laser 5 can reach the center of the tube 10.

For determining the volume flow depending on the maximum flow velocity, the flow determination unit 4 preferentially comprises a volume flow function defining the relation between the maximum flow velocity and a volume flow. This function is preferentially defined by equation (2). The flow determination unit 4 is preferentially adapted to determine the volume flow as a flow property by using the volume flow function and the maximum flow velocity.

The apparatus 1 further comprises a flow width determination unit 9 for determining the width of the flow from the determined distances of the elements. If the laser radiation 7 traverses the flow, beyond the flow no reflecting or scattering elements are present, in particular, no reflecting or scattering elements are present beyond the edge of the tube 10, and hence no distance information will come back from beyond the tube 10. Furthermore, in front of the tube, with respect to the propagation direction of the emitted laser radiation 7 no scattering or reflecting elements of the fluid 2 are present and hence, no distance information will come back from this location.

Thus, by determining the closest distance and the largest distance to the distance and velocity determination unit 3, in particular, to the laser 5 of the distance and velocity determination unit 3, the width of the flow can be determined. This determined width can, for example, be used for determining whether the laser radiation 7 penetrates the fluid 2 completely or not, for example, by comparing the determined width with the known width of the fluid 2. In this embodiment, it can be determined whether the laser radiation 7 penetrates the fluid 2 completely or not by comparing the determined width with the width of the tube 10.

Furthermore, the determined width of the flow can be used to determine the diameter of the tube 10 which is of main importance for determining the velocity profile, and once available makes a calibration superfluous. Furthermore, the determined width of the flow can be used as a control parameter to ensure that the fluid under investigation is transparent enough that scatter power is obtained from the whole cross section of the tube 10.

The distance and velocity determination unit 3 and the flow determination 4 are preferentially adapted to use a frequency modulation technique for determining distances of the elements of the fluid 2. For this reason, the distance and velocity determination unit 3 comprises preferentially a modulation apparatus 15 for modulating the frequency of the laser 5. The modulation apparatus 15 is preferentially a current driving unit that imposes preferentially a triangular modulation on the laser driving current. This current modulation leads to a corresponding modulation in the wavelength of the emitted radiation 7, if the laser 5 is a semiconductor laser as in this preferred embodiment. As a result, when changing the injection current I, the phase of the radiation increases by 360° with every additional wavelength that fits on the round-trip length from the laser 5 to the respective element of the fluid 2. Every 360° phase rotation causes one minimum and one maximum in the power of the emitted radiation 7. The number of these “undulations” Δn as a function of the wavelength variation Δλ, can be defined by following equation:

$$Δ n = Δλ \frac{d}{{λ}^{2}} , \qquad ( 4 )$$

wherein d denotes the length from the laser to the respective fluid element.

A decrease in wavelength has a similar effect as a scattering element moving away from the laser 5, where as an increase in wavelength mimics a scattering element moving towards the laser 5. If a triangular modulation of the laser current is used, the wavelength will reduce and increase periodically, mimicking periodical movements away from and towards the laser 5. The power measured by the detector 12, i.e. the intensity of the radiation 13 coupled out of the laser cavity 6, varies in time with the frequency of this triangular modulation, but now with, superposed on it, the undulations with a frequency f₀ which can be determined by using following equation:

$${f}_{0} = \frac{d λ}{d I} \cdot \frac{d I}{d t} \cdot \frac{d}{{λ}^{2}} . \qquad ( 5 )$$

The subscript in f₀ denotes that the scattering elements do not move, i.e. that the scattering element does not have a velocity component in the direction of the radiation 7. In this case, the undulation frequency is the same during the up- and down segment of the triangular modulation. Considering a moving element the frequency is, in addition, changed by the Doppler frequency. When the element is moving away, the Doppler frequency will add to f₀ during a decrease in wavelength, while it is subtracted from f₀ when the wavelength increases. This can be expressed by following equations:

fᵤₚ=f₀−f_{Doppler} and (6)

f_{down}=f₀+f_{Doppler} (7)

In equation (6) fᵤₚ denotes the frequency of the self-mixing interference signal at the up segment of the triangular modulation and f_{down} indicates the frequency of the self-mixing interference signal at the down segment of the triangular modulation.

The distance of an element to the distance and velocity determination unit 3, in particular, to the laser 5, can be determined by calculating the frequency f₀ according to following equation:

f₀=(f_{down}+fᵤₚ)/2 (8)

and by using equation (5) with the calculated frequency f₀.

The velocity of an element along the direction of the radiation 7 can be determined by calculating f_{Doppler} according to following equation:

f_{Doppler}=(f_{down}−fᵤₚ)/2 (9)

and by using equation (1) with the calculated frequency f_{Doppler}.

Since the dependency of the distance and the velocity of a single element of the fluid on the frequency of the self-mixing interference signal is known, for example, by the above described equations (1) to (7), also the dependency of the distances and velocities of several elements of the fluid on a corresponding frequency spectrum of the self-mixing interference signal is known, for example, by linearly combining the contributions of elements of the fluids, i.e. of the distances and velocities, to the frequency spectrum of the self-mixing interference signal. This known dependency is preferentially used for determining the distance distribution and the velocity distribution from the frequency spectrum of the self-mixing interference signal. For example, a simulation like a Monte-Carlo simulation can be performed knowing the above mentioned known dependency of the self-mixing interference signal spectrum on the distance and velocity distributions, wherein different spectra of the self-mixing interference signal are simulated with different distance and velocity distributions, until the simulated spectrum and the measured spectrum of the self-mixing interference signal are similar with respect to a similarity measure like a correlation or a summation of squared differences. Also a fitting procedure can be used, wherein the distance distribution and the velocity distribution are determined such that the spectrum of the self-mixing interference signal, which is determined by using the above mentioned known dependency of the spectrum of the self-mixing interference signal on the distance and velocity distributions, is fitted to the measured spectrum of the self-mixing interference signal. It is also possible to analytically calculate the distance and velocity distributions from the measured spectrum of the self-mixing interference signal by using the above mentioned known dependency.

For performing the above described simulation procedure or the above described fitting procedure the dependency of the spectrum of the self-mixing interference signal on the distance and velocity distributions can be regarded as a model. This model can include, in addition to a combination, in particular, a linear combination, of the contributions of the velocities and distances of the single elements of the fluid to the spectrum of the self-mixing interference signal, a consideration of the attenuation in the fluid and/or a consideration of the density of the fluid elements at a given velocity. These additional considerations will be described in more detail further below.

If it is assumed that without modulation of the current the spectra have the shape S(f_{Doppler)}, then, if the current is modulated, the spectrum on the upward flank can be indicated by S(|ad−f_{Doppler}|) and on the downward flank by S(|ad+f_{Doppler}|), wherein a is a proportionality constant and d is the distance of the respective element to the distance and velocity determination unit 3, in particular, to the laser 5. The frequency that a scattering particle generates is determined by the distance to the laser in conjunction with the change in frequency of the laser due to the current modulation and the velocity of the particle. The distance and velocity determination unit 3 is preferentially adapted to extract from the two spectra S(|ad−f_{Doppler}|) and S(|ad+f_{Doppler}|) the distance information and the velocity information by simulation, fitting or analytical calculation, as described above.

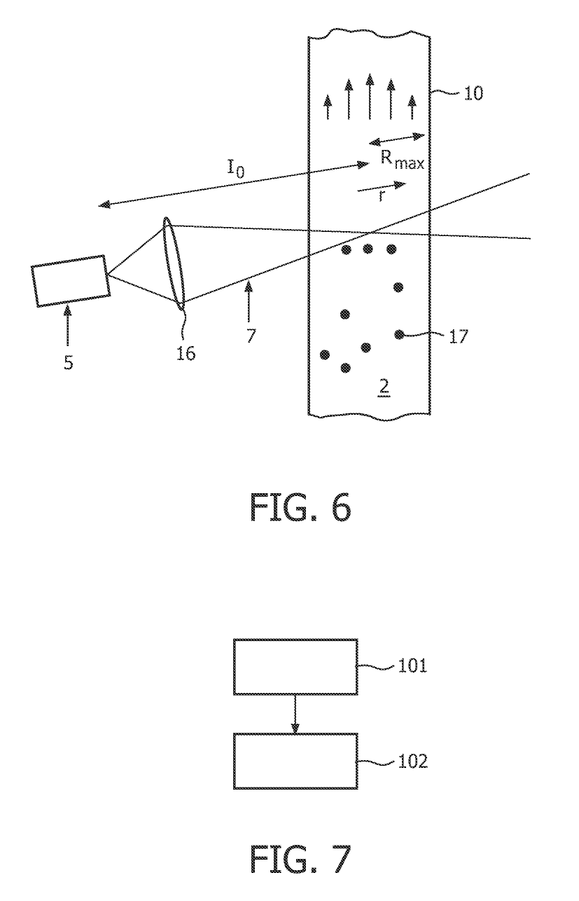

An embodiment of the determination of the distances and of the velocities of the elements in the fluid will in the following be described in more detail with reference to FIG. 6.

FIG. 6 only shows the laser 5 of the distance and velocity determination unit 3. The radiation 7 of the laser 5 traverses a lens 16 such that the radiation 7 is focused inside the fluid while propagating through the tube 10. The lens has as a function to optimize the self-mixing signal from the fluid.

The laser 5 with its optics 16 is placed outside the tube 10. The distance l₀ is the length from the laser 5, in particular, the out-coupling laser mirror of the laser cavity, towards the center of the tube 10. The letter r describes the position of the respective element 17 from the center of the tube 10 along the direction of the radiation 7. The flow velocity is generally higher along the center of the tube 10 and decrease to zero at the walls at Rₘₐₓ. The tube 10 contains a fluid 2 with scattering elements 17.

The fluid is assumed to have a laminar flow, wherein the velocity of the fluid 2 as a function of the position in the tube 10 is given by equation (1) using a correction to correct for the angle of incidence being non perpendicular to the tube surface.

$$v ( r ) = {{v}_{max} ( 1 - \frac{r sin ( φ )}{{R}_{max}} )}^{2} . \qquad ( 10 )$$

If the fluid 2 is not completely transparent to the radiation 7, the amount of backscattered light coming from a depth r in the tube 10 is given by

I_{back}=I₀e^{-α2(R}^{ₘₐₓ}^{+r)}, (11)

wherein α indicates the attenuation coefficient of the light in fluid 2.

In the following it is assumed that the density of the elements 17 is constant over the tube length, i.e. is constant in the flow direction, and that the dependence of the self-mixing interference signal strength over distance r and over the tube length is also constant. This means that preferentially the focusing action of the lens 16 is rather weak, i.e. a large depth of focus.

An element at depth r will scatter the light such that its projected component of its velocity along the direction of the radiation 7 gives rise to a Doppler frequency shift in the backscattered light as defined in equation (3).

If also a modulation of the current of the laser 5 is applied, the wavelength of the laser 5 is modulated, which leads to an additional frequency shift in the backscattered light, which can be described by following equation:

$${f}_{modulation} = \frac{- Δλ}{Δ I} \frac{Δ I}{Δ t} \frac{( {l}_{0} + r )}{{λ}^{2}} , \qquad ( 12 )$$

wherein f_{modulation} indicates the additional frequency shift and λ indicates the wavelength of the undisturbed laser 5, and lₒ is the distance of the laser towards the center of the tube.

An element 17 at a position r leads to a power spectrum, which can be described by following equation:

S(f)=g(|f_{Doppler}(r)+f_{modulation}(r)|)e^{-α2(R}^{ₘₐₓ}^{+r)}, (13)

wherein S(f) indicates the power spectrum, in particular, the intensity spectrum, measured by the detector 12 and wherein g( . . . ) indicates a response function of the self-mixing interference signal. Note that the power spectrum does not have negative frequencies. The absolute value of the resulting frequency is therefore considered. Both, the Doppler frequency shift and the modulation frequency shift, depend on the position in the fluid 2. Moreover, the signal is attenuated within the fluid.

The signal measured by the detector 12 consisting of the contribution of all the elements that back scatter light into the laser cavity 6 can be described by following equation:

Sₜₒₜₐₗ(f)=∫g(|f_{Doppler}(r)+f_{modulation}(r)|)e^{-α2(R}^{ₘₐₓ}^{+r)}dr. (14)

Equation (14) is obtained by integrating equation (13) over the position r.

If a triangular modulation is used, the wavelength change per time is constant during the upward and downward slope, only the frequency shifts have opposite signs.

The distance and velocity determination unit 3 is preferentially adapted to acquire the self-mixing interference signal on the upward flank of the triangular modulation and separately on the downward flank of the triangular modulation. From these self-mixing interference signals, a power spectrum can be calculated for the upward flank and a power spectrum can be calculated for the downward flank. Preferentially, the distance and velocity determination unit is adapted to average over several upward flanks and several downward flanks, respectively, in order to increase the signal-to-noise ratio of the power spectra.

For the upward flank the power spectrum is defined by following equation:

Sᵤₚ(f)=∫g(f_{Doppler}(r)+f_{modulation}(r)|)e^{-α2(R}^{ₘₐₓ}^{+r)}dr. (15)

For the downward flank the power spectrum can be defined by following equation:

S_{down}(f)=∫g(|f_{Doppler}(r)−f_{modulation}(r)|)e^{-α2(R}^{ₘₐₓ}^{+r)}dr. (16)

By taking an ansatz for the response function g( . . . ), for example, by taking a convolution of a Gaussian function with the density of fluid elements at a given velocity, equations (15) and (16) can be fitted to the power spectra measured by the detector 12 for the upward flank and the downward flank. The fitting procedure consists of adaptation of the fit parameters in the ansatz response function. If the fitting parameters are the maximal flow velocity and α, these parameters are determined by this fitting procedure. The maximum flow velocity can be used for determining the volume flow, for example, in accordance with equation (2).

Preferentially, the distance and velocity determination unit 3 is adapted to choose the modulation frequency of the modulation unit 15 such that the power spectrum is not passing through zero frequency as this can create some ambiguity in retrieving the velocity and distance profile. In particular, the modulation frequency is preferentially chosen such that the Doppler frequency and the modulation frequency do not have the same value. That means, if it is known that the Doppler frequency can only be within a certain frequency range, the modulation frequency is preferentially chosen such that it is not within this frequency range.

From the fitting the power spectrum can be separated in a first part, which only depends on f_{Doppler} which corresponds to the velocity distribution of the elements, and a second part, which depends only on f_{modulation}, which corresponds to the distance distribution of the elements.

In case the fluid is optically thick, the light will not penetrate deep enough into the fluid to reach the element with maximum velocity. In this case it is no longer useful to use the maximum flow velocity as a fitting parameter. However, from the two spectra of the upward and downward flank, the corresponding velocity and distance, i.e. position, of the fluid elements can be determined. The form of the spectra is given by S(f)=S(|a(r+l₀)−f_{Doppler}|) and S(f)=S(|a(r+l₀)+f_{Doppler}|), where f_{Doppler} is given by the velocity distribution only and the part that depends on l₀, is a function of the position of the fluid element only. Using a fit procedure, the two contributions can be disentangled. For example, the two unknown parameters are the absorption coefficient and the maximum flow velocity. The dependence on r of the absorption and the velocity profile are known and are used in the fitting procedure. The fit curves are optimized such that they correspond best with the two measured spectra of the upward flank and the downward flank. From the fit the distribution of the velocity as function of the distance, i.e. a velocity distribution and a distance distribution are obtained at the same time.

The flow model function, in particular, as defined in equation (1) and shown in FIG. 3, is preferentially fitted to the determined velocity and distance distribution, wherein desired flow properties can be determined from the fitted flow model function.

The modulation frequency is preferentially chosen such that it does not interfere with the part of the spectrum that is interesting for the self-mixing interference signal, i.e., as already mentioned above, the modulation frequency is preferentially chosen such that the power spectrum does not pass through zero frequency. Furthermore, the amplitude of this modulation should be so large that a few periods of modulation can be found in the detection of a non-moving object on the upward or downward part of the triangular modulation.

The distance and velocity determination unit 3, in particular, the analyzing unit 14, preferentially integrates the power spectrum obtained on the upward and downward parts of the triangular modulation separately. The power spectra of both flanks preferentially have the same shape but the frequency axis is differently scaled due to the position dependence, S(f)=S(|a(r+l₀)−f_{Doppler}|), S(f)=S(|a(r+l₀)+f_{Doppler}|) respectively.

The flow determination unit 4 is preferentially adapted to provide a flow model function defining velocities of the elements of the fluid depending on the distances of the elements to the distance and velocity determination unit 3, in particular, to the laser 5. The flow determination unit 4 is preferentially further adapted to fit the flow model function to the determined distances and velocities of the elements and to determine the flow property from the fitted flow model function.

The flow model is preferentially a laminar flow model, which assumes that the maximum flow velocity is located in the middle of the flow and the zero flow values are located at the edge of the flow. Such a preferred flow model function is schematically and exemplarily shown in FIG. 3. This fitting of the flow model function to the determined distances and velocities of the elements of the fluid can be performed, even if only the distances and velocities of a few elements of the fluid have been determined. Thus, even if the fluid is optically thick. If, for example, distances and velocities of elements can be determined only, which have a distance to the distance and velocity determination unit 3, which corresponds to a normalized radius between −1.0 and −0.5, the flow model function can be fitted to the distances and velocities of these elements and, for example, the maximum flow velocity and, thus, also the volume flow, can be determined based on the fitted flow model function.

In an embodiment, the distance and velocity determination unit 3 and the flow determination unit 4 are adapted such that

a) if the determined width is equal to or larger than a predefined maximal velocity width, the distance and velocity determination unit 3 determines the maximum frequency of the self-mixing interference signal and determines the maximum flow velocity of the elements of the fluid from the determined maximum frequency, and the flow determination unit 4 determines the maximum flow velocity as the flow property,

b) if the determined width is smaller than the predefined maximal velocity width, the flow determination unit provides a flow model function defining velocities of elements of the fluid depending on the distances of the elements to the distance and velocity determination unit, fits the flow model function to the determined distances and velocities of the elements, and determines the flow property from the fitted flow model function.

The predefined maximal velocity width defines the width of the flow, which has at least to be determined by the flow width determination unit 9, in order to allow determining the maximum flow velocity from the generated self-mixing interference signal. This determined width of the flow depends on the optical thickness of the fluid 2, i.e. the penetration depth of the radiation 7 in the fluid 2. Thus, by determining a flow property of the fluid 2 in dependence on the determined width of the flow, the determination of the flow property depends on the optical thickness of the fluid 2. If the optical thickness is low such that the laser radiation 7 reaches the maximal velocity width, the distance and velocity determination unit 3 and the flow determination unit 4 are adapted to determine a maximum flow velocity by determining Doppler frequencies from the self-mixing interference signal, by determining the maximum Doppler frequency of the determined Doppler frequencies, and by determining the maximum flow velocity of the elements of the fluid 2 from the determined maximum Doppler frequency. If the optical thickness is large such that the laser radiation 7 cannot reach the maximum velocity width, the flow determination unit 4 provides the flow model function defining velocities of the elements of the fluid 2 depending on the distances of the elements to the distance and velocity determination unit 3, fits the model function to the determined distances and velocities of the elements, and determines the flow property from the fitted flow model function. This allows determining the flow property of the fluid 2 depending on the optical thickness of the fluid 2.

It is further preferred that the flow determination unit 4 is adapted to determine whether the flow of the fluid 2 is laminar or turbulent from the self-mixing interference signal as the flow property. The flow determination unit 4 is preferentially adapted to determine that the flow is turbulent, if a frequency spectrum of the self-mixing interference signal has a chaotic behavior, and to determine that the flow is laminar, if the frequency spectrum of the self-mixing interference signal has not a chaotic behavior, in particular, if the frequency spectrum of the self-mixing interference signal has a well-established shape. The flow determination unit 4 is coupled to the pump 11 such that, if the flow determination unit 4 determines that the flow of the fluid 2 is turbulent, the pump 11 is controlled such that the flow of the fluid 2 becomes laminar. Thus, the apparatus 1 can be adapted such that a laminar flow of the fluid 2 within the tube 10 is obtained and/or maintained by using a control loop comprising the distance and velocity determination unit 3, the flow determination unit 4 and the pump 11.

In the following a method for determining a flow property of a fluid will be described with reference to a flow chart shown in FIG. 7.

In step 101, the distance and the velocity determination unit 3 determines distances of elements 17 of the fluid 2 to the distance and velocity determination unit 3 and velocities of the elements 17 at the same time. A self-mixing interference signal is generated by directing laser radiation 7 generated within the laser cavity 6 to the fluid 2 for being reflected by the fluid 2. The reflected radiation 8 is mixed with the radiation within the laser cavity 6 and the distances and the velocities of the elements 17 within the fluid 2 are determined based on the generated self-mixing interference signal.

In step 102, the flow property determination unit 4 determines a flow property of the fluid based on at least one of the determined distance and velocities. Preferentially, the flow property determination unit determines the maximum flow velocity and the volume flow based on the determined distances and the determined velocities of the elements 17.

The precise measurement of flows is an important and critical task in many different applications, reaching from industrial processes, for example, chemistry or food processing, over machines like, for example, car engines up to medical applications like blood transfusions or infusions. In most cases, due to the different nature of the liquids or gasses used, the different applications require different solutions for the precise determination of the amount of liquid or gas that passed a certain tube (volume flow), ranging from mechanical flow meters, over thermal detectors up to ultrasonic devices. In contrast, the apparatus for determining a flow property of a fluid in accordance with the invention is able to precisely measure flow velocities in media of dramatically different nature. The sensor, i.e. the distance and velocity determination unit, is based on self-mixing interference in the laser cavity 6 of a laser 5, which is preferentially a semiconductor laser. The apparatus for determining a flow property of a fluid in accordance with the invention is capable of determining the flow velocities and volume flow in media with a high attenuation of the laser radiation 7 as well as in transparent media.

The apparatus for determining a flow property of a fluid in accordance with the invention can be used in a huge variety of applications, in particular, in the above mentioned applications.

As already described above, for generating the self-mixing interference signal the interference inside the laser cavity 6 between the laser light and external feedback is used. The principle of laser self-mixing interference allows non-contact velocity and distance measurement. If the laser 5 is aimed at a scattering element 17 a small portion of the scattered light reflects into the laser cavity 6 where it mixes with the strong laser field. When the movement of the element 17 has a component along the direction of the laser beam 7, the phase of the reflected light continuously shifts with respect to the original laser light, resulting in a periodic variation of the feedback in the laser cavity 6 at a frequency equal to the Doppler frequency. This is explained in more detail above and also in the article “Laser diode self-mixing technique for sensing applications”, G. Giuliani, M. Norgia, S. Donati and T. Bosch, J. Opt. A: Pure Appl. Opt. 4, 283-294, 2002, which is herewith incorporated by reference.

The apparatus for determining a flow property of a fluid uses a laser sensor that is based on the principle of self-mixing interference to measure preferentially the laminar flow of liquids or gasses independently of the nature of the medium. The apparatus can be used for the measurement of flows of transparent as well as scattering or absorbing media. The apparatus achieves this by combining the measurement of a velocity distribution of the scattering elements with a measurement of the distance distribution of the scattering elements. For media, i.e. fluids, with a large attenuation coefficient, the radiation 7 will not penetrate deep enough into the fluid 2 to reach the region of maximum velocity. Hence, the maximum velocity cannot be determined directly. To solve this problem, the apparatus determines the position distribution, e.g. the distance distribution, of the scattering elements 17 within the fluid 2 together with the velocity distribution of these elements 17. This yields the penetration depth of the radiation 7 in the fluid 2 and the position of the maximum velocity in the measured self-mixing interference signal, i.e. the position of the maximum velocity of the velocities of the elements 17, from which radiation is backscattered. By using the flow model function, in particular, by using the flow model function shown in FIG. 3, this maximum obtained velocity and the corresponding position can be used to determine the overall maximum velocity in the flow by fitting the flow model function to the maximum obtained velocity and the corresponding position.

It should be noted that the same apparatus, in particular, the same laser sensor, is used for determining the velocities and the distances of the elements.

The laser 5 is preferentially a semiconductor laser, in particular, a vertical-cavity surface-emitting laser (VCSEL).

Although in the above described embodiments a certain configuration for determining a self-mixing interference signal has been described, in other embodiments, other configurations for determining a self-mixing interference signal can be used.

Although in the above described embodiments flow properties of a fluid in a tube are determined, in other embodiments flow properties of fluids can be determined, which are not flowing in a tube. For example, flow properties of a fluid flowing freely or in a channel or a cavity being different to a tube can be determined by the apparatus in accordance with the invention.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or devices may fulfill the functions of several items recited in the claims. The mere fact that certain measures are recited in mutually different dependent claims does not indicate that a combination of these measures cannot be used to advantage.

Calculations and/or determinations, like the determination of the distances and the velocities of the elements in the fluid or like the determination of the maximum flow velocity or the volume flow, performed by one or several units or devices can be performed by any other number of units or devices. The calculations and/or determinations and/or the control of the apparatus for determining a flow property of a fluid in accordance with the above described method for determining a flow property of a fluid can be implemented as program code means of a computer program and/or as dedicated hardware.

A computer program may be stored/distributed on a suitable medium, such as an optical storage medium or a solid-state medium, supplied together with or as part of other hardware, but may also be distributed in other forms, such as via the Internet or other wired or wireless telecommunication systems.

Any reference signs in the claims should not be construed as limiting the scope.

1. An apparatus for determining a flow property of a fluid, the apparatus comprising:
a distance and velocity determination unit for determining distances of elements of the fluid to the distance and velocity determination unit and for determining velocities of the elements at the same time, the distance and velocity determination unit comprising a laser with a laser cavity, wherein the distance and velocity determination unit is adapted to generate a self-mixing interference signal by directing laser radiation generated within the laser cavity to the fluid for being reflected by the fluid and by mixing the reflected radiation with the radiation within the laser cavity and to determine the distances and the velocities based on the generated self-mixing interference signal,
a flow determination unit for determining the flow property of the fluid (2) based on at least one of the determined distances and velocities.

2. The apparatus as defined in claim 1, wherein the flow determination unit is adapted to determine at least one of the maximum flow velocity and the volume flow as the property of the fluid.

3. The apparatus as defined in claim 1, wherein the distance and velocity determination unit is adapted to:
determine Doppler frequencies from the self-mixing interference signal,
determine the maximum Doppler frequency of the determined Doppler frequencies,
determine the maximum flow velocity of the elements of the fluid from the determined maximum Doppler frequency,
wherein the flow determination unit is adapted to determine the maximum flow velocity as the flow property.

4. The apparatus as defined in claim 3, wherein the flow determination unit is adapted to:
provide a volume flow function defining the relation between the maximum flow velocity and a volume flow,
determine the volume flow as the flow property by using the volume flow function and the maximum flow velocity.

5. The apparatus as defined in claim 1, wherein the apparatus further comprises a flow width determination unit for determining the width of the flow from the determined distances of the elements.

6. The apparatus as defined in claim 1, wherein the flow determination unit is adapted to:
provide a flow model function defining velocities of the elements of the fluid depending on the distances of the elements to the distance and velocity determination unit,
fit the flow model function to the determined distances and velocities of the elements,
determine the flow property from the fitted flow model function.

7. The apparatus as defined in claim 1, wherein the apparatus further comprises:
a flow width determination unit for determining the width of the flow from the determined distances of the elements,
wherein the distance and velocity determination unit and the flow determination unit are adapted such that
a) if the determined width is equal to or larger than a predefined maximal velocity width, the distance and velocity determination unit determines the maximum frequency of the self-mixing interference signal and determines the maximum flow velocity of the elements of the fluid from the determined maximum frequency, and the flow determination unit determines the maximum flow velocity as the flow property,
b) if the determined width is smaller than the predefined maximal velocity width, the flow determination unit provides a flow model function defining velocities of elements of the fluid depending on the distances of the elements to the distance and velocity determination unit, fits the flow model function to the determined distances and velocities of the elements, and determines the flow property from the fitted flow model function.

8. The apparatus as defined in claim 1, wherein the flow determination unit is adapted to determine whether a flow of the fluid is laminar or turbulent from the self-mixing interference signal as the flow property.

9. The apparatus as defined in claim 8, wherein the flow determination unit is adapted to determine that the flow is turbulent, if a frequency spectrum of the self-mixing interference signal has a chaotic behavior, and wherein the flow determination unit is adapted to determine that the flow is laminar, if a frequency spectrum of the self-mixing interference signal has not a chaotic behavior.

10. A method for determining a flow property of a fluid, the method comprising the steps of:
determining distances of elements of the fluid to the distance and velocity determination unit and for determining velocities of the elements at the same time, wherein a self-mixing interference signal is generated by directing laser radiation generated within a laser cavity to the fluid for being reflected by the fluid, wherein the reflected radiation is mixed with the radiation within the laser cavity and wherein the distances and the velocities are determined based on the generated self-mixing interference signal,
determining the flow property of the fluid based on at least one of the determined distances and velocities.

11. A computer program for determining a flow property of a fluid, the computer program comprising program code means for causing an apparatus to carry out the steps of the method as defined in claim 10, when the computer program is run on a computer controlling the apparatus.
